(19) United States
(12) Patent Application Publication
(10) Pub. No.: US 2026/0178639 A1
(43) Pub. Date: Jun. 25, 2026

(54) DEFECT SEARCHING METHOD AND ELECTRIC DEVICE

(71) Applicant: Wistron Corporation, New Taipei City (TW)

(72) Inventors: Jesica Elizabeth Marchelina, New Taipei City (TW); Ya Ting Chang, New Taipei City (TW); Ya Ying Hsu, New Taipei City (TW)

(73) Assignee: Wistron Corporation, New Taipei City (TW)

(21) Appl. No.: 19/047,655

(22) Filed: Feb. 7, 2025

(30) Foreign Application Priority Data
Dec. 23, 2024 (TW) 113150092

(51) Int. Cl. G06F 16/3349; G06F 40/284

(52) U.S. Cl. CPC G06F 16/3349; G06F 16/33295; G06F 40/284

(57) ABSTRACT

A defect searching method is provided. The defect searching method includes the following steps. An issue description input by a user is obtained. A light code is extracted from the issue description, and a database is searched according to the light code to obtain a first search result. An error code is extracted from the issue description, and the database is searched according to the error code to obtain a second search result. A symptom is extracted from the issue description, and the database is searched according to the symptom to obtain a third search result. An action is extracted from the issue description, and the database is searched according to the action to obtain a fourth search result. The first search result, the second search result, the third search result, and the fourth search result are integrated to retrieve an item from the database.

### CROSS-REFERENCE TO RELATED APPLICATION

This application claims the priority benefit of Taiwan application serial no. 113150092, filed on Dec. 23, 2024. The entirety of the above-mentioned patent application is hereby incorporated by reference herein and made a part of this specification.

### BACKGROUND

### Technical Field

The disclosure relates to a defect searching method capable of addressing variability in user input to find a correct item.

### Description of Related Art

Currently, when defects or issues occur during the development process of a product, engineers typically record relevant error codes or write issue descriptions. These records are then used as a basis to search a database for corresponding items for subsequent processing. For example, engineers may retrieve known issues or solutions in the system by inputting specific error codes. Additionally, they may rely on textual descriptions to match historical data to determine the root cause of the issue or possible solutions.

However, multiple challenges exist in this process. Engineers may use different languages, abbreviations, or even input errors when recording error codes or writing descriptions, which significantly reduces the accuracy of database searches. Furthermore, textual descriptions may be ambiguous or lack uniformity. For instance, the same issue may be expressed in various ways, further increasing the complexity of matching. Currently, some fuzzy matching techniques are applied to address such problems, such as calculating the cosine distance between strings. However, these approaches have limited capability to understand semantics.

### SUMMARY

Disclosed is a defect searching method and an electronic device, which may simultaneously consider information such as a light code and an error code to accurately search for a required item.

Disclosed is a defect searching method, applicable to an electronic device. The defect searching method includes the following steps. An issue description input by a user is obtained. A light code is extracted from the issue description, and a database is searched according to the light code to obtain a first search result. An error code is extracted from the issue description, and the database is searched according to the error code to obtain a second search result. A symptom is extracted from the issue description, and the database is searched according to the symptom to obtain a third search result. An action is extracted from the issue description, and the database is searched according to the action to obtain a fourth search result. The first search result, the second search result, the third search result, and the fourth search result are integrated to retrieve one of multiple items from the database.

From another perspective, the embodiments of the disclosure provide an electronic device, which includes: a memory, storing multiple instructions; and a processor, electrically connected to the memory and used to execute the instructions to perform the above-mentioned defect searching method.

To make the features and advantages of the disclosure more comprehensible, several embodiments accompanied with drawings are described in detail as follows.

### BRIEF DESCRIPTION OF THE DRAWINGS

FIG. 1 illustrates a schematic diagram of an electronic device according to an embodiment.

FIG. 2 illustrates a flowchart of a defect searching method according to an embodiment.

FIG. 3 illustrates a flowchart of extracting a light code according to an embodiment.

FIG. 4 illustrates a table of light codes input by a user according to an embodiment.

FIG. 5 illustrates an example table of error strings according to an embodiment.

FIG. 6 illustrates a flowchart of extracting an error code according to an embodiment.

FIG. 7 illustrates a flowchart of extracting a symptom and an action according to an embodiment.

FIG. 8 illustrates a schematic diagram of search results of the disclosed technology and conventional technology.

FIG. 9 illustrates a schematic diagram of search results of the disclosed technology and conventional technology.

### DESCRIPTION OF THE EMBODIMENTS

Some embodiments of the disclosure will be described in detail below with reference to the accompanying drawings. In the following description, reference numbers cited for elements, when appearing in different drawings, are considered to represent the same or similar elements. These embodiments are only a part of the disclosure and do not disclose all possible implementations of the disclosure. More specifically, these embodiments are merely examples of the systems and methods within the scope of the patent claims of the disclosure.

The terms “first,” “second,” and the like, as used herein, do not specifically indicate any order or sequence but are only intended to distinguish elements or operations described using the same technical terminology.

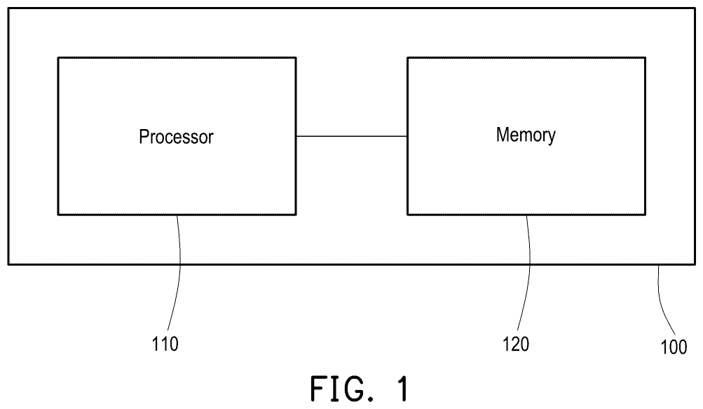

FIG. 1 illustrates a schematic diagram of an electronic device according to an embodiment. Referring to FIG. 1, an electronic device 100 may be a tablet computer, personal computer, laptop computer, server, distributed computer, cloud server, industrial computer, or various electronic devices with computing capabilities, and the disclosure is not limited thereto. The electronic device 100 includes a processor 110 and a memory 120, wherein the processor 110 is electrically connected to the memory 120. The processor 110 may be a central processing unit, microprocessor, microcontroller, application-specific integrated circuit, or the like, and the memory 120 may be random-access memory, read-only memory, flash memory, floppy disk, hard disk, optical disk, USB flash drive, magnetic tape, or a database accessible via the internet. The memory 120 stores multiple instructions, and the processor 110 executes these instructions to perform a defect searching method.

The defect searching method presented in this embodiment is applicable to a product development engineer. In other embodiments, it may also apply to customer service personnel, quality control personnel, or others, and the disclosure is not limited thereto. In this embodiment, the product is a laptop computer. However, in other embodiments, the product may also be a personal computer, server, communication device, or any electronic product.

First, the database contains multiple items, and each item includes information such as a light code, an error code, a symptom, and an action. For example, the light code may be “1A8W,” where “A” represents “Amber” and “beep,” and “W” represents “White.” The error code may be “0x0000007E.” A symptom indicates what happened, and an action represents when it happened. Here, a user inputs an issue description, and the goal is to search for the correct item to provide to the user for subsequent troubleshooting or related processing.

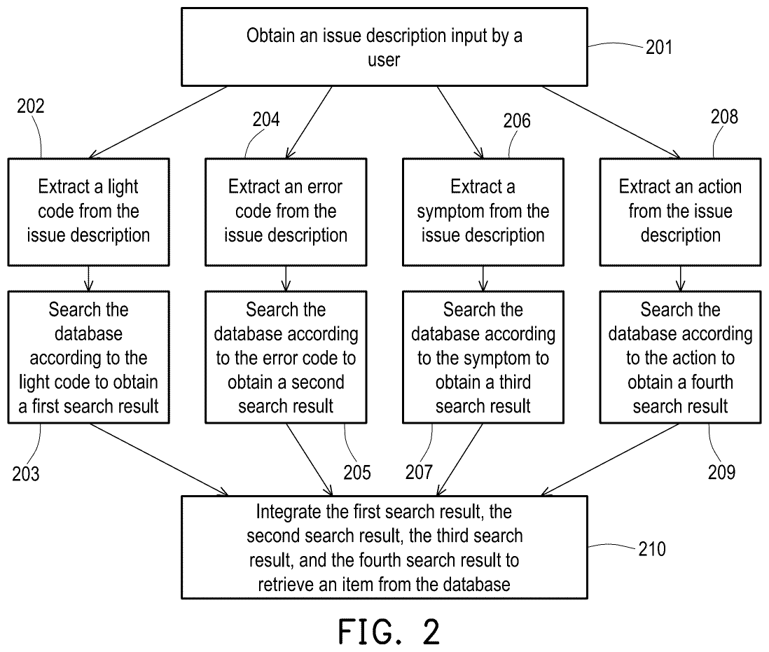

FIG. 2 illustrates a flowchart of a defect searching method according to an embodiment. In step 201, an issue description input by a user is obtained. For example, the issue description includes “LED Code 1 amber 8 blue.” The user may not input a light code, error code, or other information in a standard format, and sometimes may mix two languages (e.g., Chinese and English) with inconsistent terminology.

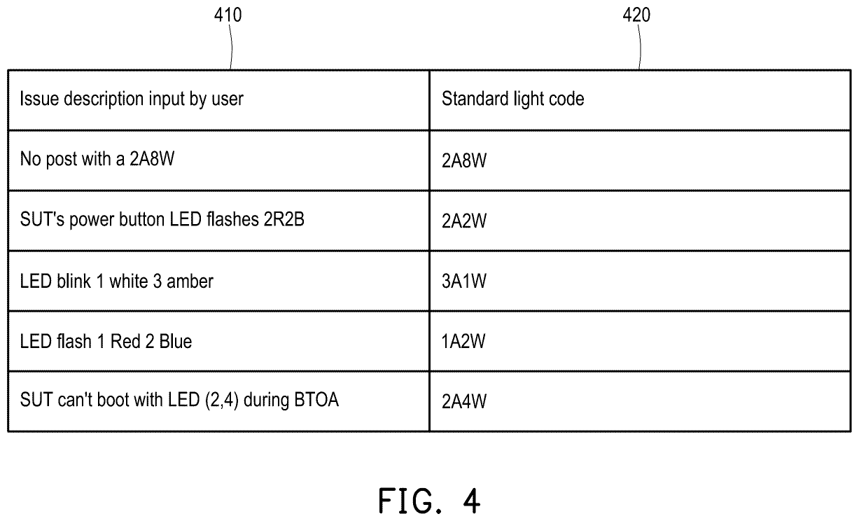

In step 202, a light code is extracted from the issue description. User input and corresponding standard light codes are pre-analyzed to establish predefined rules. FIG. 4 illustrates a table of light codes input by a user according to an embodiment. Referring to FIG. 4, a first column 410 shows issue descriptions input by the user, and a second column 420 shows standard light codes. Users may sometimes input descriptions such as “2R2B,” “1 white 3 amber,” or tuples like (2,4). According to predefined rules, the light descriptions in the issue description are converted into standard light codes. For example, predefined rules may be used for abbreviation conversion, phrase conversion, and tuple conversion. Abbreviation conversion includes converting Y (Yellow), O (Orange), R (Red), and F (Flash) into A (Amber) and converting B (Blue) into W (White). Phrase conversion standardizes inconsistent phrases such as “5 Amber,” “5 ambers,” or “one amber” into a standard format like “5A” or “1A.” Phrase conversion may also adjust the order, such as converting “1W3A” into “3A1W.” Tuple conversion processes tuples like (2,4) or ½. When detecting two numbers separated by symbols such as slashes, commas, or parentheses, it is necessary to check if the issue description contains a keyword (e.g., “LED,” “light code”). If the issue description contains the keyword, tuples like (2,4) or ½ are converted to “2A4W” or “1A2W,” respectively, to reduce errors.

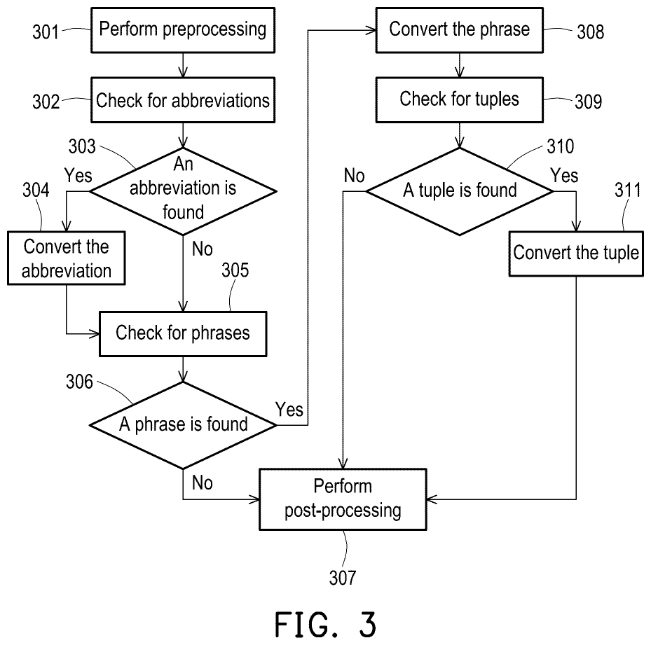

FIG. 3 illustrates a flowchart of extracting a light code according to an embodiment. Referring to FIG. 3, in step 301, preprocessing is performed, such as translating Chinese to English, cleaning text, and correcting spelling. In step 302, abbreviations are checked, such as determining if terms like “Amber” exist. In some embodiments, fuzzy matching, rough set theory, or other suitable algorithms may be used to find abbreviations during the abbreviation check. In step 303, it is determined whether an abbreviation is found. If yes, abbreviation conversion is performed in step 304. In step 305, phrases are checked, such as determining if numbers (in English or numeric form) and specific words are present. Additionally, different orders, capitalization, and plural forms may be checked. In step 306, it is determined whether a phrase is found. If yes, phrase conversion is performed in step 308. If no phrase is found, post-processing is performed in step 307. After phrase conversion, tuples are checked in step 309. Tuples may be in forms such as containing parentheses or slashes. In step 310, it is determined whether a tuple is found. If yes, tuple conversion is performed in step 311. Otherwise, post-processing is performed in step 307. In step 307, duplicate light codes may be removed. Additionally, it may be checked whether these light codes exist in the database, and if not, they are deleted. The flowchart of FIG. 3 is merely an example. In other embodiments, abbreviation conversion, phrase conversion, and tuple conversion may be performed in any order or involve one or more of these processes.

Referring to FIG. 2, step 203 is then performed, wherein the database is searched according to the light code to obtain a first search result. The search result may include whether the light code is found, all the items that are found, or assigning a score to each item (e.g., a score of 1 if found, or 0 if not found). The content of the search result is not limited in the disclosure.

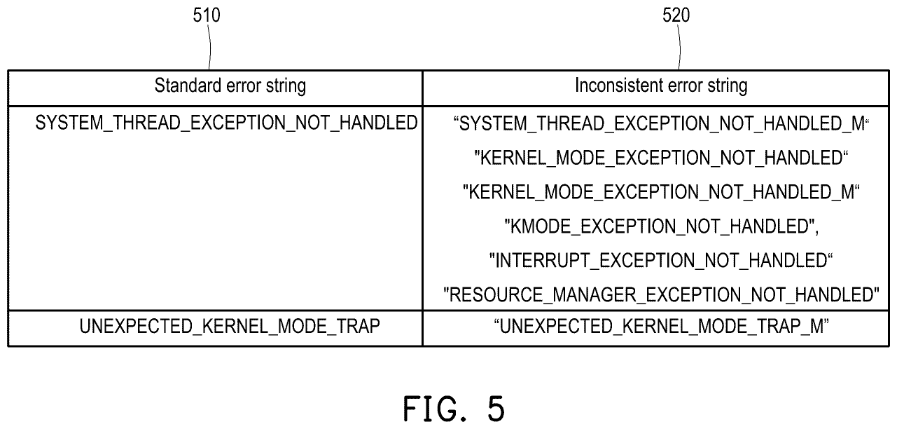

In step 204, an error code is extracted from the issue description. The error code may be in numeric form (e.g., 0x0000007E), in an abbreviated form (e.g., 0x7E), or may include an error string (e.g., NMI_HARDWARE_FAILURE). In some embodiments, each numeric form of an error code corresponds to an error string, and either one (numeric form or error string) is found in the issue description. FIG. 5 illustrates an example table of error strings according to an embodiment. Referring to FIG. 5, a first column 510 contains standard error strings, while a second column 520 contains inconsistent (variable) error codes.

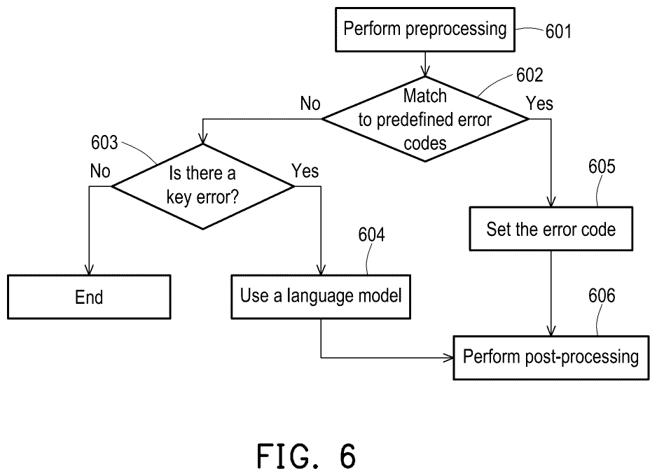

FIG. 6 illustrates a flowchart of extracting an error code according to an embodiment. Referring to FIG. 6, in step 601, preprocessing is performed, such as cleaning text, converting strings to uppercase, and replacing spaces or special characters. In step 602, it is determined whether the issue description matches one of multiple predefined error codes in the database. Fuzzy matching, rough set theory, or other suitable algorithms may be used to match the issue description to the predefined error codes. If a matching predefined error code is found, the matched predefined error code is treated as the extracted error code in step 605. In some embodiments, numeric forms of error codes have two syntaxes: one is hexadecimal (e.g., 0x7E), and the other is called ePsa (e.g., 2000_1234). The extracted error code is also standardized, such as converting “2000_1234” into “0x2000_1234.” Post-processing is then performed in step 606.

If the result of step 602 is negative, in step 603, whether the issue description contains a key error is determined. The key error may include issues such as a Blue Screen of Death (BSOD). If the result of step 603 is negative, the process ends, indicating that no error code was extracted. If the result of step 603 is affirmative, a language model is used in step 604 to extract the error code. The language model may be from the GPT series, BERT series, or other suitable models, and the disclosure is not limited thereto. Specifically, a string in the issue description may be split into multiple words. For example, the string “KMODE_EXCEPTION_NOT_HANDLED” may be split into four words: “KMODE,” “EXCEPTION,” “NOT,” and “HANDLED.” For each word, predefined error codes containing the word are searched to generate multiple candidate error codes. Then, the string from the issue description and the candidate error codes are input into the language model, which is instructed to select the error code from the candidate error codes. For instance, the prompt may be: “You will act as a string matcher. I have an error string input by a user. Please select the most semantically similar error code from these candidate error codes.” Then, post-processing is performed in step 606. Post-processing includes removing duplicate error codes. If the extracted error code is not found in the database, the extracted error code is also deleted.

Referring to FIG. 2, step 205 is then executed, wherein the database is searched according to the error code to obtain a second search result. The search result may include whether the error code is found, the few closest items, or assigning a score to each item (e.g., a score of 1 if found, or 0 if not found). The disclosure is not limited to the content of the search result.

In step 206, a symptom is extracted from the issue description. In step 208, an action is extracted from the issue description. Steps 206 and 208 are performed together. In some embodiments, a language model is used to interpret the semantics of the issue description and extract the symptom and the action. Zero-shot or few-shot approaches may be used with the language model. For example, the issue description and one or more examples may be input into the language model, where each example includes an issue description stored in the database along with the extracted symptom and action. This allows the language model to extract the symptom and action from the user's current issue description by following the examples.

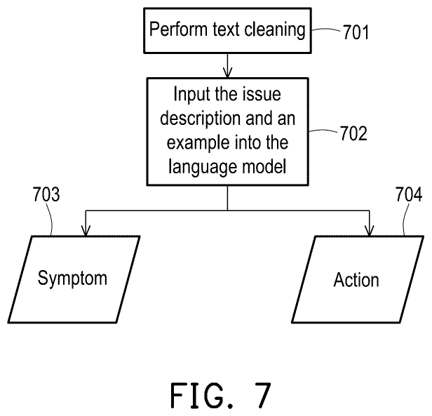

FIG. 7 illustrates a flowchart of extracting a symptom and an action according to an embodiment. Referring to FIG. 7, in step 701, text cleaning is performed. In step 702, the issue description and examples are input into the language model, and a symptom 703 and an action 704 are then obtained. In some embodiments, the language model may also be instructed to rewrite the symptom 703 and the action 704 based on principles of conciseness and clarity. The language model may handle issue descriptions in any language. After processing, the symptom 703 may be used to describe what happened, and the action 704 may be used to describe when it happened.

Referring back to FIG. 2, in step 207, the database is searched according to the symptom to obtain a third search result. In some embodiments, since the symptom is one or more strings, cosine similarity or other similarity metrics may be used to find similar items from the database. Alternatively, in some embodiments, a score may be assigned to each item based on cosine similarity. In step 209, the database is searched according to the action to obtain a fourth search result. Similarly, cosine similarity or other similarity metrics may be used to find similar items from the database, or a score may be assigned to each item based on cosine similarity.

In step 210, the first search result, the second search result, the third search result, and the fourth search result are integrated to retrieve one item from the database. In some embodiments, each search result contains some items, and the intersection of these search results may be taken to retrieve the item. In some embodiments, for each item in the database, each search result may be used to calculate a score, referred to as the first score, the second score, the third score, and the fourth score, respectively. For example, regarding the light code, if an item matches the light code, the first score is 1; otherwise, it is 0. Regarding the error code, if an item matches the error code, the second score is 1; otherwise, it is 0. On the other hand, the third score may be calculated based on the cosine similarity between the symptom and the symptom of the item (the two are positively correlated). The fourth score may be calculated based on the cosine similarity between the action and the action of the item (the two are positively correlated). For each item, a weighted sum of the first score, the second score, the third score, and the fourth score may then be calculated. For example, the weight of the first score may be 1; the weight of the second score may be 1; the weight of the third score may be 1; and the weight of the fourth score may be 0.5. These weight settings are merely examples, and the disclosure is not limited thereto. Next, the items in the database are sorted based on the calculated weighted sum, and the top-ranked item is retrieved as the output.

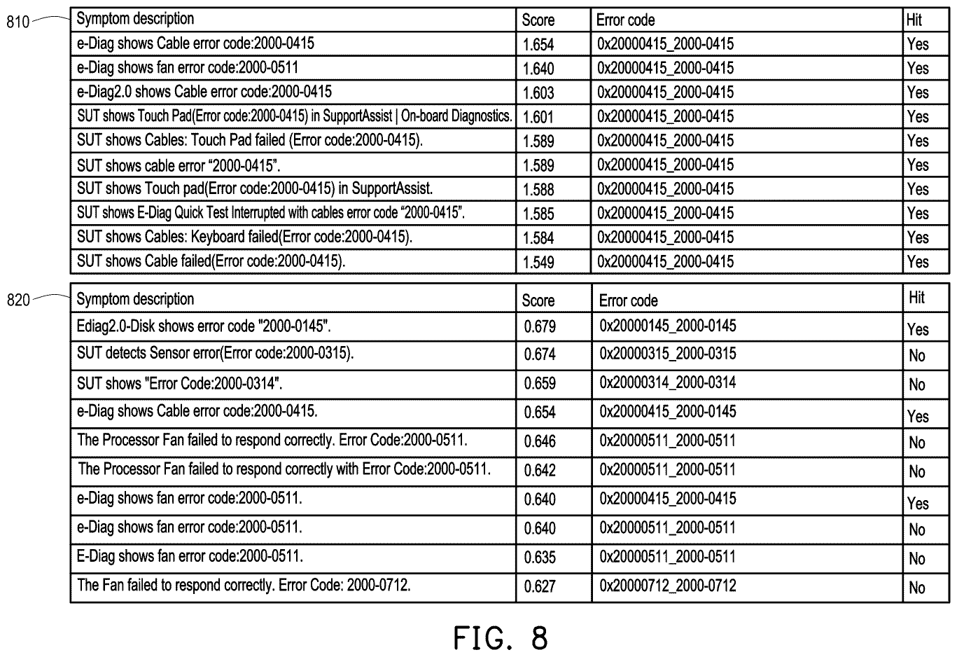

FIG. 8 illustrates a schematic diagram of the search results of the disclosed technology and conventional technology. Referring to FIG. 8, in this example, the user's issue description is “How to Solve if error code 2000-0415 appears.” A table 810 contains the search results of this embodiment, with items sorted according to “scores” (i.e., the weighted sum described above). The “Hit” column indicates whether the search result meets the user's needs. A table 820 contains the search results of conventional technology, where the “scores” are cosine similarity values. As shown in FIG. 8, a disadvantage of using cosine similarity is that it may find error codes like “20000315.” Although most digits are the same, the error code represented is different.

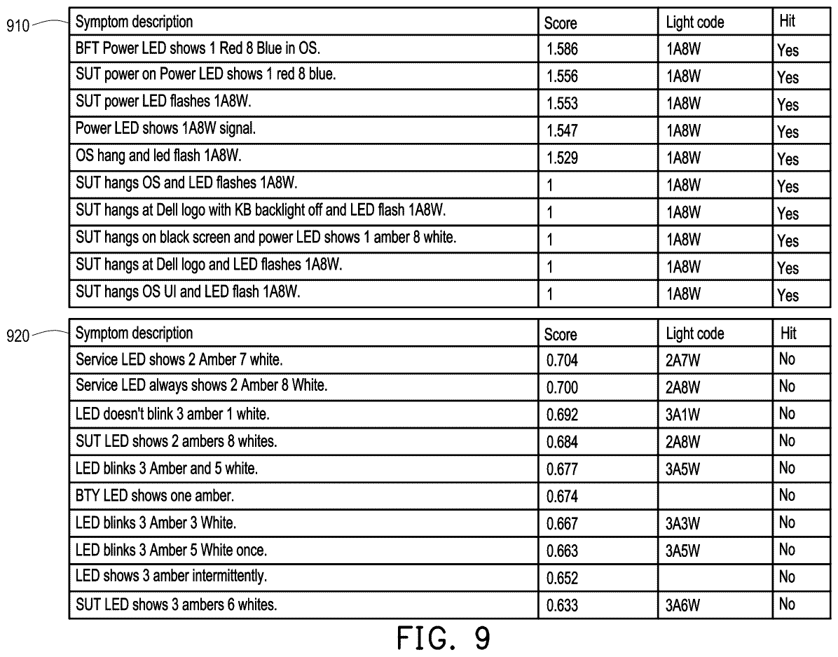

FIG. 9 illustrates a schematic diagram of the search results of the disclosed technology and conventional technology. Referring to FIG. 9, in this example, the user's issue description is “LED code 1 amber 8 blue.” A table 910 contains the search results of this embodiment, with items sorted according to “scores” (i.e., the weighted sum described above). The “Hit” column indicates whether the search result meets the user's needs. A table 920 contains the search results of conventional technology, where the “scores” are cosine similarity values. As shown in FIG. 9, a disadvantage of using cosine similarity is that it finds many descriptions containing “LED,” but the light codes differ significantly.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

1. A defect searching method, applicable to an electronic device, the defect searching method comprising:
obtaining an issue description input by a user;
extracting a light code from the issue description, and searching at least one database according to the light code to obtain a first search result;
extracting an error code from the issue description, and searching the at least one database according to the error code to obtain a second search result;
extracting a symptom from the issue description, and searching the at least one database according to the symptom to obtain a third search result;
extracting an action from the issue description, and searching the at least one database according to the action to obtain a fourth search result; and
integrating the first search result, the second search result, the third search result, and the fourth search result to retrieve one of a plurality of items from the at least one database, wherein the first search result includes information on whether the one of the plurality of items contains a matching light code that matches the light code.

2. The defect searching method according to claim 1, wherein extracting the light code from the issue description comprises:
converting a light description in the issue description into a standard light code according to a predefined rule.

3. The defect searching method according to claim 2, wherein converting the light description in the issue description into the standard light code according to the predefined rule comprises:
performing an abbreviation conversion, a phrase conversion, and a tuple conversion.

4. The defect searching method according to claim 1, wherein extracting the error code from the issue description comprises:
determining whether the issue description matches one of a plurality of predefined error codes;
if the issue description matches the one of the plurality of predefined error codes, setting the matched one of the plurality of predefined error codes as the error code;
determining whether the issue description contains an error; and
if the issue description does not match the plurality of predefined error codes, and the issue description contains the error, using a language model to extract the error code.

5. The defect searching method according to claim 4, wherein using the language model to extract the error code comprises:
splitting a string of the issue description into a plurality of words;
for each of the plurality of words, searching the plurality of predefined error codes containing the each of the plurality of words to generate a plurality of candidate error codes;
inputting the string and the plurality of candidate error codes into the language model to select the error code from the plurality of candidate error codes.

6. The defect searching method according to claim 1, further comprising:
inputting the issue description and an example into a language model to obtain the symptom and the action.

7. The defect searching method according to claim 1, wherein integrating the first search result, the second search result, the third search result, and the fourth search result comprises:
for each of the plurality of items, calculating a first score according to the first search result, calculating a second score according to the second search result, calculating a third score according to the third search result, and calculating a fourth score according to the fourth search result;
for the each of the plurality of items, calculating a weighted sum of the first score, the second score, the third score, and the fourth score; and
sorting the plurality of items according to the weighted sum to obtain the one of the plurality of items.

8. An electronic device, comprising:
a memory, storing a plurality of instructions; and
a processor, electrically connected to the memory, and used to execute the plurality of instructions to complete a plurality of steps:
obtaining an issue description input by a user;
extracting a light code from the issue description, and searching at least one database according to the light code to obtain a first search result;
extracting an error code from the issue description, and searching the at least one database according to the error code to obtain a second search result;
extracting a symptom from the issue description, and searching the at least one database according to the symptom to obtain a third search result;
extracting an action from the issue description, and searching the at least one database according to the action to obtain a fourth search result; and
integrating the first search result, the second search result, the third search result, and the fourth search result to retrieve one of a plurality of items from the at least one database, wherein the first search result includes information on whether the one of the plurality of items contains a matching light code that matches the light code.

9. The electronic device according to claim 8, wherein extracting the light code from the issue description comprises:
converting a light description in the issue description into a standard light code according to a predefined rule.

10. The electronic device according to claim 9, wherein converting the light description in the issue description into the standard light code according to the predefined rule comprises:
performing an abbreviation conversion, a phrase conversion, and a tuple conversion.

11. The electronic device according to claim 8, wherein extracting the error code from the issue description comprises:
determining whether the issue description matches one of a plurality of predefined error codes;
if the issue description matches the one of the plurality of predefined error codes, setting the matched one of the plurality of predefined error codes as the error code;
determining whether the issue description contains an error; and
if the issue description does not match the plurality of predefined error codes, and the issue description contains the error, using a language model to extract the error code.

12. The electronic device according to claim 11, wherein using the language model to extract the error code comprises:
splitting a string of the issue description into a plurality of words;
for each of the plurality of words, searching the plurality of predefined error codes containing the each of the plurality of words to generate a plurality of candidate error codes;
inputting the string and the plurality of candidate error codes into the language model to select the error code from the plurality of candidate error codes.

13. The electronic device according to claim 8, wherein the plurality of steps further comprises:
inputting the issue description and an example into a language model to obtain the symptom and the action.

14. The electronic device according to claim 8, wherein integrating the first search result, the second search result, the third search result, and the fourth search result comprises:
for each of the plurality of items, calculating a first score according to the first search result, calculating a second score according to the second search result, calculating a third score according to the third search result, and calculating a fourth score according to the fourth search result;
for the each of the plurality of items, calculating a weighted sum of the first score, the second score, the third score, and the fourth score; and
sorting the plurality of items according to the weighted sum to obtain the one of the plurality of items.
